(19) United States
(12) Patent Application Publication
(10) Pub. No.: US 2013/0312773 A1
(43) Pub. Date: Nov. 28, 2013

(54) Collapsible Leg Support

(71) Applicant: Chris Molle, Jensen Beach, FL (US)

(72) Inventor: Chris Molle, Jensen Beach, FL (US)

(21) Appl. No.: 13/480,575

(22) Filed: May 25, 2012

(51) Int. Cl. A61G 15/12

(52) U.S. Cl. 128/882

(57) ABSTRACT

The present invention provides a modular device and kit utilizing a plurality of individual components which form an easily collapsible and transportable leg support used to support the leg, foot, and/or ankle in a fixed position. Accordingly, when the components are arranged together, the assembled configuration forms a three-dimensional leg support device. In the unassembled position, the individual components are designed to maintain a generally planar shape so that each of the pieces that form the assembled unit can lay flat against each other. In this configuration, the collapsible leg support device can be easily stored, shipped, or moved from place to place.

### FIELD OF THE INVENTION

The present invention generally relates to devices for maintaining one or more portions of the human lower extremity in a fixed position. More particularly, the present invention provides a modular device and kit utilizing a plurality of individual components which form an easily collapsible and transportable leg support used to support the leg, foot, and/or ankle in a fixed position.

### BACKGROUND OF THE INVENTION

Injuries involving the human lower extremity, such as the toe, foot, or ankle, can occur as a result of many causes, the most common being trauma. In the most serious traumas, surgical intervention is often required. Upon completion of such surgical intervention, the individual is often required to immobilize and refrain from heavy use of the injured body part to allow for complete recovery. While not all foot injures are serious enough to require surgical intervention, proper treatment in non-surgical injuries also requires preventing the injured from suffering pain and risking further damage. Most foot injuries involving fractures, as well as sprains and strains, caused by sports or work related activities can be treated with the home remedy of rest, ice, compression, elevation (RICE). To significantly increase recovery time, a three day regime of RICE, particularly when inflammation is present, is often suggested by physicians. Such treatment helps minimize any inflammation, pain, and swelling that is associated with the injury.

Devices for maintaining the foot, or portions thereof, in a fixed position are known in the art. Such devices include casts, splints, or elevation devices that are generally designed to fix the foot, ankle, or toe in place. For example, U.S. Pat. No. 5,385,534 describes a splint and kit for assembling the splint. The splint is described as including a plurality of components which, when assembled, provide a device which conforms to the upper portion of the leg. The components include a support member, a pad for cushioning the support member against the leg, and one or more straps for securing the support member to the body. A pair of flexible members for fixedly retaining the flexion angle of the support member is also described.

U.S. Pat. No. 5,449,339 describes a heel supporting protective boot. The boot is described as being useful for bed patients. The boot comprises a formed flexible, compressible foam material and leg supporting portions for supporting a patient's foot. While the boot is designed to fix the foot inserted therein in place, the device fails to prevent the foot from horizontal movement when a patient is sleeping, and is generally made of thick foam which can be uncomfortable. Moreover, the boot is described as being compressible; however, repeated compression can result in shape deformity. Also, the size makes it difficult to ship and store.

U.S. Pat. No. 5,603,692 describes a foot drop leg splint which is described as useful for stabilizing a patient's foot. The splint is described as having a rigid support frame with a contoured foam insert. Removable straps are used to hold the splint onto the patient. The leg splint is formed of a unitary piece and therefore makes it difficult to ship. Moreover, given the size of the device, storage of the device can be problematic.

U.S. Pat. No. 6,572,573 describes a heel elevating device designed to help reduce chaffing, skin shear, pressure sores or pressure ulcers. The device is described as containing a self-standing, generally U-shaped lower leg support. This device is similar to other devices that utilize a foam block base for support. Similar to the other devices, such construction is difficult to ship, requires space for storage, and can be uncomfortable in use.

U.S. Pat. No. 6,920,657 describes an elevation device adapted to support an extremity of a patient. The device is described as utilizing the packaging for the device to form a finished product. The disadvantage of this device is that it requires a significant space when shipped as the device is formed from a three dimensionally shaped shipping box.

### SUMMARY OF THE INVENTION

The present invention provides a modular device and kit utilizing a plurality of individual components which form an easily collapsible and transportable leg support used to support the leg, foot, and/or ankle in a fixed position. In the unassembled position, the individual components are designed to maintain a generally planar shape so that each of the pieces that form the assembled unit can lay flat against each other. In this configuration, the collapsible leg support device can be easily stored, shipped, or moved from place to place.

In a preferred, albeit illustrative example, the collapsible leg support device has a plurality of components assembled together to form a three-dimensional configuration constructed and arranged to maintain one or more portions of a human lower extremity in a fixed position. The leg support comprises a first side wall having a first end, a second end, and a first side wall main body. The first side wall has at least one first connector member of a first connector assembly and at least one first connector member of a second connector assembly. The leg support device further includes a second side wall having a first end, a second end, and a second side wall main body. The second side wall has at least one first connector member of a first connector assembly, and at least one first connector member of a second connector assembly. The first and second walls are arranged in a substantially parallel manner and spaced apart to form an area sized to contain one or more portions of a human lower extremity. A back wall panel has a second connector member of said first connector assembly. At least one stabilizing member is secured to the first and second side walls with the stabilizing member containing a second connector member which engages the first connector member to form a second connector assembly. Preferably, the first connector assembly provides for a first position engagement and a second secured position where at least one of the connector members is translatable, or moves relative to the other to properly align and secure the corresponding components.

Accordingly, it is an objective of the present invention to provide a leg support that is easily transportable.

It is a further objective of the present invention to provide a leg support that can be easily and quickly assembled.

It is yet another objective of the present invention to provide a leg support that can be easily and quickly disassembled.

It is a still further objective of the present invention to provide a leg support that can be easily stored using minimal space.

It is a further objective of the present invention to provide a leg support which is inexpensive to ship.

It is yet another objective of the present invention to provide a leg support device that prevents or minimizes movement of the leg when in an elevated position.

It is a still further objective of the present invention to provide a leg support device that provides for maintaining the position of the leg when in an elevated position.

It is a further objective of the present invention to provide a leg support kit that is easily transportable.

It is yet another objective of the present invention to provide a leg support kit that is easily stored using minimal space.

It is a still further objective of the present invention to provide a leg support kit which is inexpensive to ship.

It is a further objective of the present invention to provide a leg support that can be readily assembled from a kit.

It is yet another objective of the present invention to provide a leg support that can be readily assembled from a kit wherein the kit enables practical storage and transportation.

It is a still further objective of the present invention to provide a leg support that can be readily assembled from a kit wherein the kit is compact.

It is a further objective of the present invention to provide a leg support that can be readily assembled from a kit wherein the kit is stackable.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a right side perspective view of an illustrative embodiment of the collapsible leg support in the assembled configuration in accordance with the present invention;

FIG. 2 is a left side perspective view of the collapsible leg support in the assembled configuration;

FIG. 3 is a front view of the collapsible leg support in the assembled configuration;

FIG. 4 is a back view of the collapsible leg support in the assembled configuration;

FIG. 5 illustrates the leg support in the disassembled configuration and placed in a shipping and/or storage container;

FIG. 6 is a side view of an illustrative embodiment of a first side wall of the collapsible leg support;

FIG. 7 is a side view of an illustrative embodiment of a second side wall of the collapsible leg support;

FIG. 8 is front view of an illustrative embodiment of a back wall of the collapsible leg support;

FIG. 9 is a back view of the back wall of the collapsible leg support illustrated in FIG. 8;

FIG. 10 is front view of an alternative illustrative embodiment of a hack wall of the collapsible leg support;

FIG. 11 is a side view of the back wall of the collapsible leg support illustrated in FIG. 10;

FIG. 12 is a side view of an illustrative embodiment of a second horizontal support structure of the collapsible leg support;

FIG. 13A is a side view of an illustrative embodiment of a first horizontal support structure of the collapsible leg support;

FIG. 13B is a side view of an alternative embodiment of the first horizontal support structure of the collapsible leg support;

FIG. 14 is an exploded view of the collapsible leg support illustrated in FIG. 1;

FIG. 15A illustrates the interconnection of the first connector member and the second connector member in the first contact position;

FIG. 15B illustrates the interconnection of first connector member and the second connector member in the second secured position;

FIG. 15C is a cross sectional view taken along lines 15C-15C in FIG. 15B;

FIG. 15D illustrates an alternative embodiment of the first and second connector members;

FIG. 16 is a front perspective view of an illustrative embodiment of the collapsible leg support in the assembled configuration and having a leg inserted therein.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

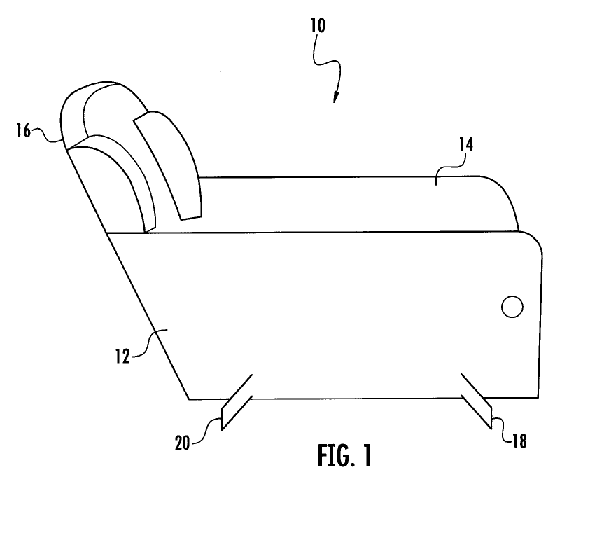

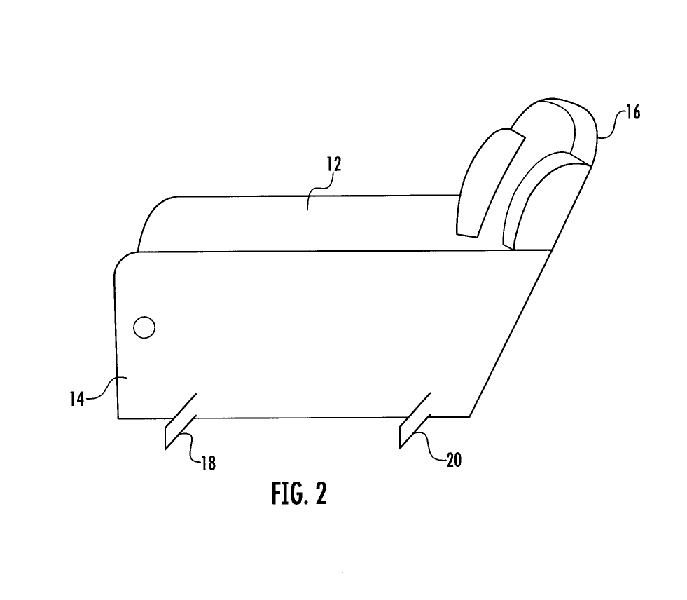

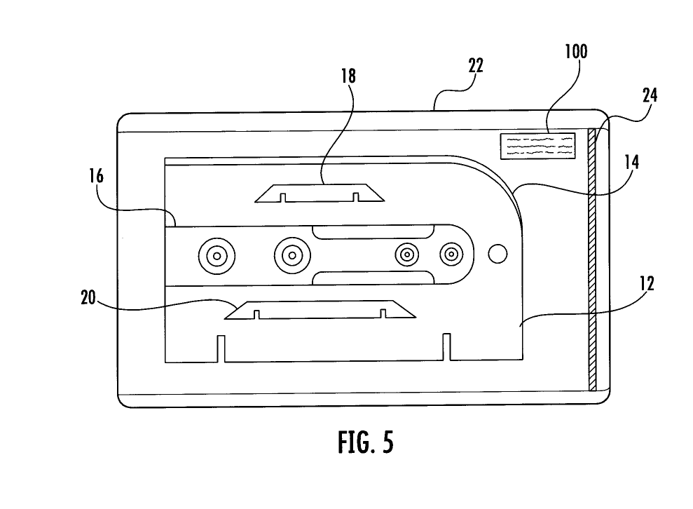

Referring to FIGS. 1-4, a collapsible leg support device 10 is illustrated. The collapsible leg support device generally includes a first side wall 12, a second side wall 14, a back wall 16, and stability structures 18, and 20. The collapsible leg support device 10 is comprised of a plurality of individual components which, when assembled, form a three dimensional structure that can be used by patients to maintain the leg, foot, ankle, or toes inserted therein in a relatively stable position. In the unassembled position, the individual pieces are designed to maintain a generally planar shape so that each of the pieces that form the assembled unit can lay flat against each other. In this configuration, the collapsible leg support device 10 can be easily stored, shipped, or moved. Referring to FIG. 5, the individual components, such as the first side wall 12, the second side wall 14, the back wall 16, and the stability structures 18 and 20 can be contained in a bag 22 which contains a resealable zipper mechanism 24, such as the sealing mechanisms used in ZIPLOC® bags. In this manner, the collapsible leg support device 10 can be shipped or stored as a kit containing the necessary components to form the desired assembled, three dimensional configuration.

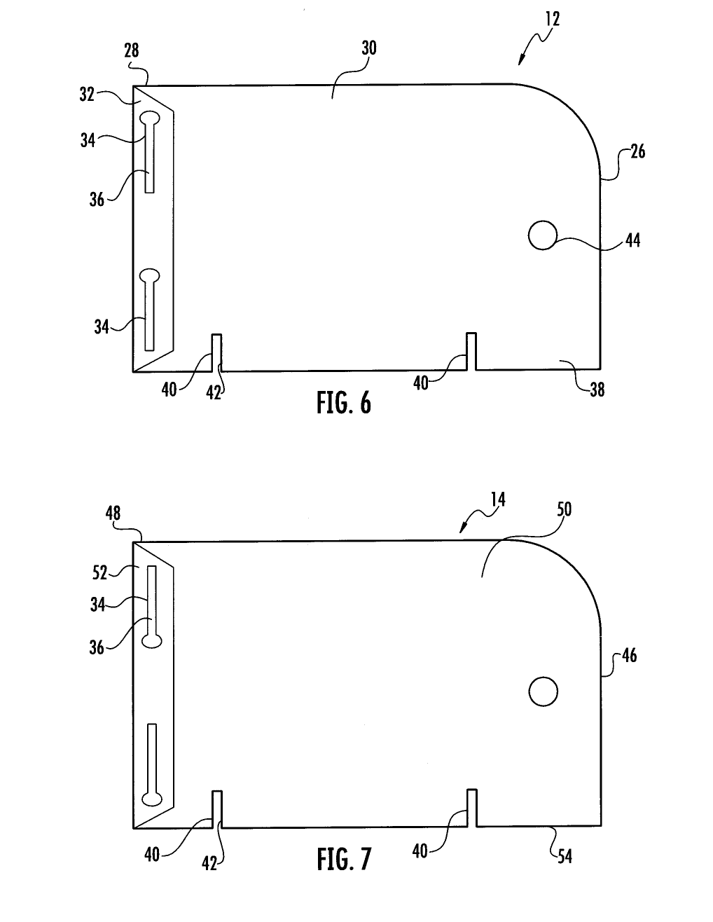

Referring to FIGS. 6 and 7, the collapsible leg support device 10 contains like-constructed first and second side walls, or panels, 12 and 14. The first side wall 12 contains a first end 26, a second end 28, and a main body 30 there between. The distance between the first end 26 and the second end 28 can be varied and defines the length of the first side wall 12. Integrally formed with or attached to the second end 28 is a second panel member 32 which forms a generally L-shaped configuration with the main body 30 formed through a right angle or curvature. The second panel member 32 contains one or a plurality of first connector members 34, illustrated herein as a keyhole shaped slotted member 36. The keyhole shaped slotted member 36 is sized and shaped to receive a second connector member as described later. Along the bottom edge 38 is a plurality of first horizontal stability connector members, illustrated herein as slotted members 42. The main body 30 may contain an aperture 44.

The second side wall 14 contains a first end 46, a second end 48, and a main body 50 there between. The distance between the first end 46 and the second end 48 can be varied and defines the length of the second side wall 14. Integrally formed with or attached to the second end 48 is a second panel member 52 which forms a generally L-shaped configuration with the main body 50 formed through a right angle or curvature. The second panel member 52 contains one or a plurality of first connector members 34, illustrated herein as keyhole shaped slotted member 36. The keyhole shaped slotted member 36 is sized and shaped to receive the second connector member. Along the bottom edge 54 is a plurality of first horizontal stability connector members 40 illustrated herein as slotted members 42. The main body 50 may also contain an aperture 44.

Both the side walls 12 and 14 are sized and shaped generally to the same dimensions so that the first wall 12 can be placed on the second wall 14, or vice versa, and fit together. The second panels 32 and 52 can be constructed and arranged to be nestable within each other, thereby minimizing the space needed when disassembled and arranged in kit configuration. Preferably, the first and second side walls 12 and 14, as well as the other components of the device, may be made of any strong, sturdy and light weight material, such as but not limited to plastics. However, each of the components may be made from other materials such as metals, including steel, wood or wood composites. Additionally, the device 10 may be designed so that some components are made of one type of material, i.e. plastic materials, and other components are made of second, different material, i.e. metal.

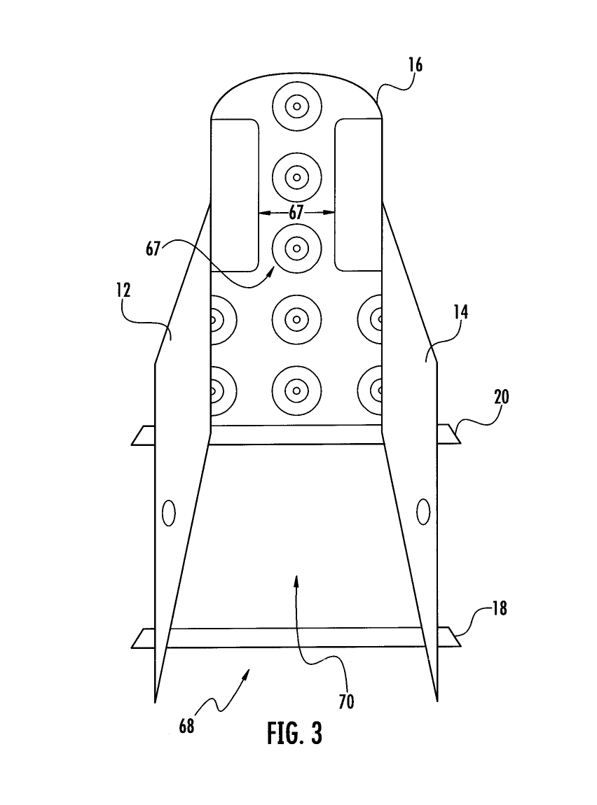

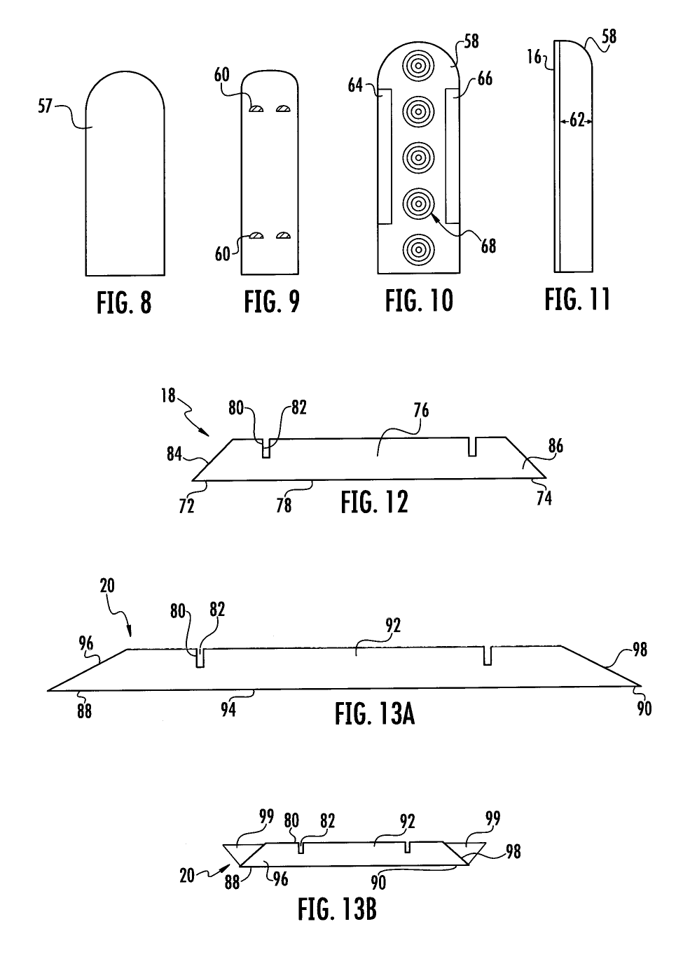

A back wall or back wall panel 16 is used to provide support and act as a stress reducing mechanism when a leg is inserted to maintain the inserted foot in a comfortable position. Additionally, the back wall panel can be adapted to prevent side-to-side movement of the foot while being stabilized. The back wall panel 16 contains a first inner surface 56 which makes contact directly or indirectly with the foot inserted within the device 10, see FIG. 8, and a second outer surface 57. The second outer surface 57 contains one or a plurality of second connector members 60. The second connector members 60 are constructed and arranged to engage the first connector members 34 to form a first connector assembly. The first connector assembly provides secure connection between the first and second side walls 12, 14 and the back panel 16. Coupled to the first inner surface 56 is coupled to a pad or cushion 58, see FIGS. 10 and 11. The cushion 58, illustrated herein as a foam piece can have varied thickness 62 and may contain ribbing or other indentations. Coupled to the cushion 58 or directly to the back panel 16 are foot support structures 64 and 66, illustrated herein as vertically arranged, generally tubular structures. Such shape and arrangement, however, is illustrative only and not intended to be limiting. The support structures 64 and 66 are sized and spaced apart to form a passageway 67, see FIG. 3, for which all or a portion of an individual's foot can rest.

Once the back wall panel 16, the first side wall 12 and the second side wall 14 are engaged, they form a partially enclosed structure with an open front area 68, see FIG. 3, and a foot securing channel 70. The side walls 12 and 14 are shown in a generally parallel arrangement, but may also be aligned in a partially diverging arrangement. The construction of the collapsible device 10, therefore, allows for maintaining the leg in a horizontal position with the foot in a vertical position resting against the back wall 16. Horizontal or side-to-side movement is minimized or prevented thereby allowing the foot to properly heal. The collapsible device 10 further includes stabilizing members 18 and 20 which prevent the device from moving in a side-to-side manner. Prior devices, like a boot or foam member, may function to fix the leg in one position, however, they are susceptible to being moved as the entire leg or foot moves as well. In contrast, use of the stabilizing members in accordance with the present invention prevents the entire device from moving should the inserted leg move.

Referring to FIGS. 12 and 13A, illustrative examples of the stabilizing members 18 and 20 are shown. In the illustrative example, the stabilizing members 18 and 20 contain like features. Stabilizing member 18 is illustrated as a horizontally positioned bar having a first end 72, a second end 74, and a planar main body 76. A bottom edge 78 preferably is sized to allow contact with a surface, such as a floor or bed mattress. The planar main body 76 contains one or more second horizontal stability connector members 80, illustrated herein as slotted portion 82, which are sized, shaped and arranged to engage with the first horizontal stability connector members 40 to form a second connector assembly, or a horizontal stability connector assembly. Each of the ends 72 and 74 may contain an angled surface 84 and 86 for increased stability.

Stabilizing member 20 is illustrated as a horizontally positioned bar having a first end 88, a second end 90, and a planar main body 92. A bottom edge 94 preferably is sized to allow contact with a surface, such as a floor or bed mattress. The planar main body 92 contains one or more second horizontal stability connector members 80, illustrated herein as slotted portion 82, which are sized, shaped and arranged to engage with the first horizontal stability connector members 40 to form a second connector assembly, or a horizontal stability connector assembly. Each of the ends 88 and 90 may contain an angled surface 96 and 98 for increased stability. The stabilizing member 20 may also include a horizontal plate 99, see FIG. 13B, arranged in a generally perpendicular manner to the planar main body 92, and extending outwardly to provide enhanced stability when the collapsible leg support device 10 is assembled.

In use, the collapsible leg support in accordance with the present invention could be distributed to an individual at a point of injury treatment facility, such as a hospital emergency room or physician's office. The unique advantage of the present invention is that the individual components of the device 10 can be easily stored as a kit, unassembled in bag 22, see FIG. 5, which because of the planar nature of the components can easily be stored in a hospital setting where space can be a premium. The bag 22 contains the necessary components as well as an instruction card 100 describing or illustrating how the components fit together. Upon being instructed that the injured leg requires immobilization, the physician distributes the bag 22 to the patient. Since the kit components are neatly placed in the bag, transporting the kit is easy and does not require too much room once placed in a transportation vehicle.

Alternatively, the collapsible leg support can be provided in a kit format that is available to the patients at commercial points of sale, such as a drug store, pharmacy, general merchandise store or online via the internet, by mail order, etc., whereby the patient obtains the kit independent from his/her physician or facility. In either case, when the patient is in need of immobilizing his/her leg, including the foot, ankle, and toes, the patient assembles the device 10. The device 10 is designed to be securely placed on most surfaces, such as a floor or couch. In many instances, the device is used when the patient is sleeping. Accordingly, the device can be assembled and placed on a mattress of a bed.

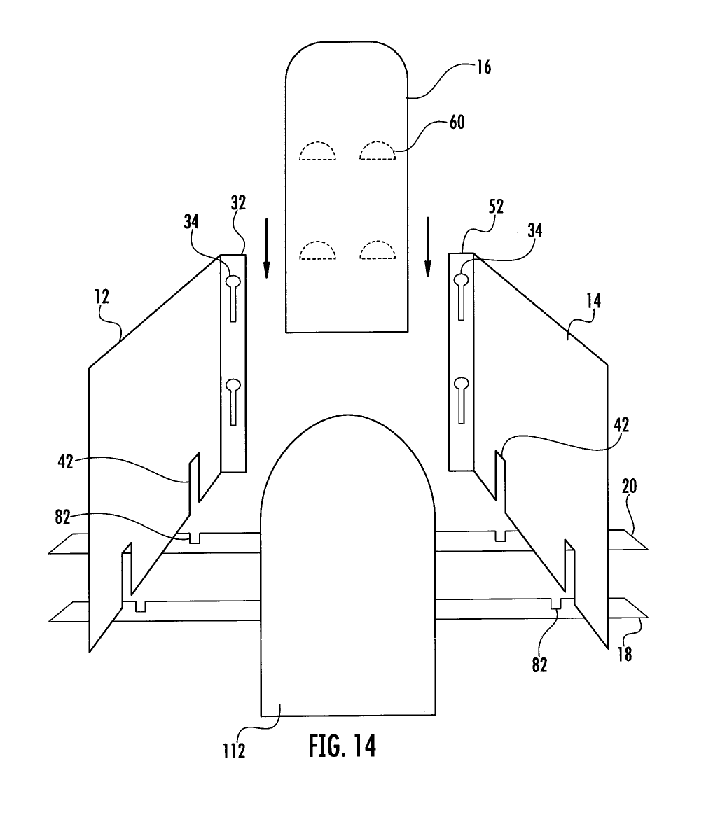

Referring to FIG. 14, each of the components of the collapsible leg support 10 are designed to form a three dimensional structure. In assembling the collapsible leg support 10, the side walls 12 and 14 engage and secure to the back wall 16 to form a generally U-shaped configuration. To form this configuration, the individual aligns the first side wall 12 and the second side wall 14 in a substantially parallel manner. The back wall 16 is positioned so that the first connector members 34 align with the second assembly members 60 to form the first connector assembly. While the first connector assembly could include first and second members that lock together, such as a dado type connection, it is preferable that the first connector assembly include first and second members that connect at a first position and translate to a second secured position. In the second secured position, the connected components, i.e. the first and second side walls 12, 14 and the back panel 16, are tightly secured and properly aligned with each other.

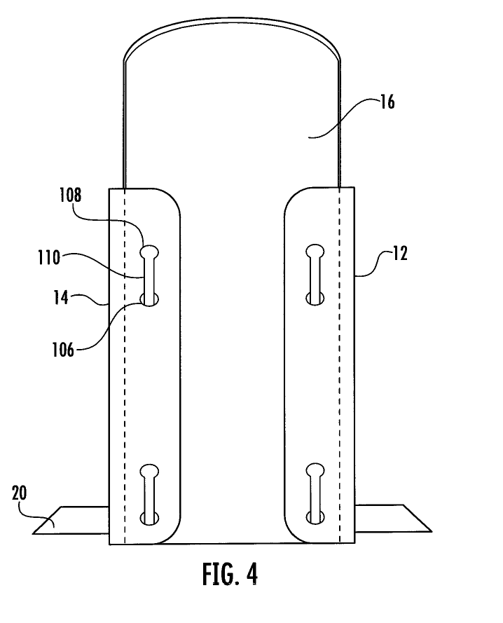

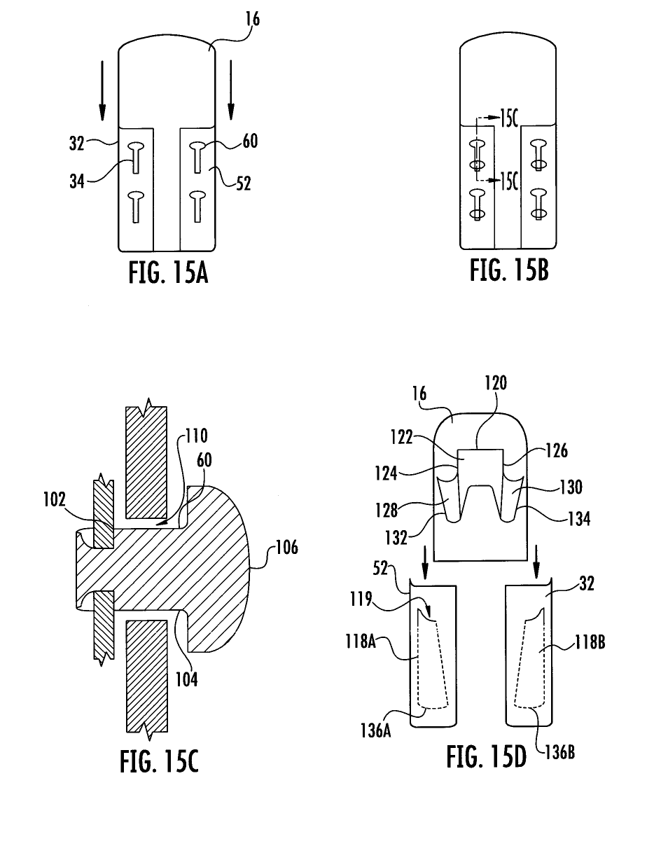

As illustrated in the embodiments described previously, the first connector assembly utilized requires a first contact and translation to a second secured position. Referring back to FIGS. 14 and 15A-15C, the second connector members 60 positioned on the outer surface 58 of the back panel are aligned with the plurality of keyhole shaped slotted members 34 positioned on the second panel member 32 of the first side panel 12 and the second panel member 52 of the second side wall 14. As illustrated in FIG. 15C, the second connector member 60 contains a cylindrical body 102, such as a pin, with a terminal end 104 having a knob-like structure 106. The knob-like structure 106 is inserted into the circular portion 108 of the keyhole shaped slotted members 34, see FIG. 4. As the back panel 16 is translated to a second position by moving the panel downwardly, arrows on FIG. 15A, the knob-like structure 106 and the cylindrical body 102 move within the slotted portion 110, see FIG. 4 and FIG. 15C, of the keyhole shaped slotted members 34, locking in place. Once in the second position, the second connector member 60 is prevented from disengaging the keyhole shaped slotted members 34. In this configuration, the three walls 12, 14 and 16 are in the proper alignment and secured to each other.

FIG. 15D illustrates an alternative embodiment of the first and second members of the first connector assembly. In a similar manner to that described previously, the embodiment illustrated in FIG. 15D requires a first contacting position and translation to a second securing position in which the connected components are secured together. As shown in FIG. 15D, the second panel member 32 of side wall 12 and the second panel 52 of side wall 14 include one portion of the first connector member, illustrated herein as slide bracket receiving channels 118A and 118B. The slide bracket receiving channels 118A and 118B are constructed and arranged to receive one or more portions of a second connector member secured to the back wall panel 16. Accordingly, the slide bracket receiving channels 118A and 118B contain opening 119, and may be tapered to fit angled sides of the second connector. The second connector member, illustrated herein as a slide bracket 120 having a back wall 122, two generally parallel side walls 124 and 126, and winged wedge-like portions 128 and 130. The winged, wedge-like portions 128 and 130 are sized and shaped to slidably engage the slide bracket receiving channels 118A and 118B. The winged, wedge-like portions 128 and 130 may contain tapered edges 132 and 134 which engage the tapered or angled portion of the slide bracket receiving channels 118A and 118B to securely fit the first and second members together. The bottom portions 136A and 136B are connected to the back wall panel 16 to prevent the winged wedge-like portions 128 and 130 from sliding through the slide bracket receiving channels 118A and 118B.

The stabilizing members 18 and 20 are then secured to the bottom of the collapsible device 10, see FIG. 14. The stabilizing member 18 is aligned so the bottom surface 78 is in contact with the mattress surface and the slotted portion 82 aligns with the slotted openings 42 located on the first and second panels 12 and 14. The stabilizing device 20 is also aligned so the bottom surface 94 is in contact with the mattress surface and the slotted portion 82 aligns with the slotted openings 42 located on the first and second panels 12 and 14. Once in proper alignment, the device 10 is pushed down onto the stabilizing members, securing in place. Use of the securing members 18 and 20 prevents the device 10 from moving should the entire leg move as well. This can be important in situations, such as at night when a person tends to move in his/her sleep. Such movement increases the possibility the foot moves as well, resulting in the failure to maintain proper placement, such as being in an elevated position, thereby reducing the effectiveness of the recovery immobilized positioning. The present invention minimizes such risks and allows the device, and therefore the foot, to remain in its original position, even if the entire leg moves.

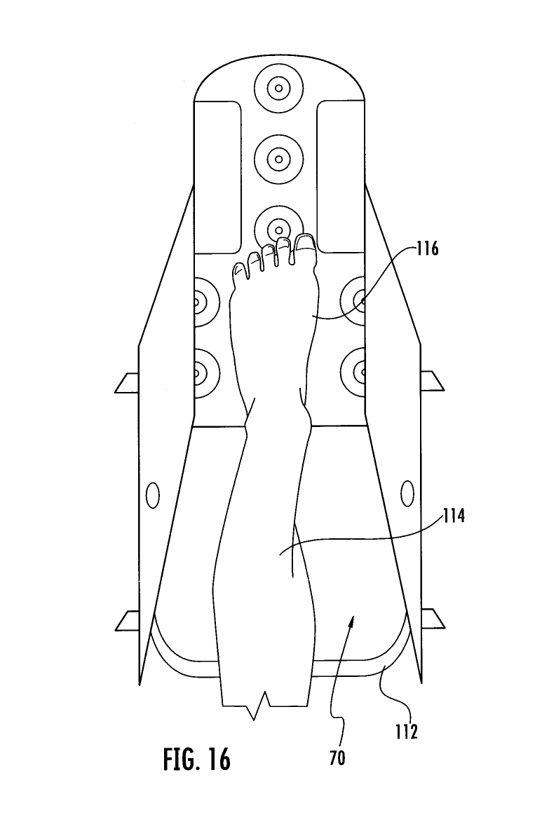

A bottom support panel 112, see FIG. 16, may be inserted between the first side wall 12 and the second side wall and resting on stabilizing members 18 and 20. The bottom support panel 112 may be sized and shaped to securely fit within the space between the side walls 12 and 14 or may contain male/female type connectors such as for example, tabs or recessed slotted portion sized and shaped to receive tabs (not illustrated). Additionally, or alternatively, the bottom support may be a soft material, such as a pillow, see FIG. 16, or a cushioned material. If a pillow and a support panel are both used, the pillow may rest directly on the bottom support panel 112. Once assembled, the user inserts his/her leg 114 into the channel portion 70, with the foot 116 contacting a portion of the back panel 16 and resting in-between structures 64 and 66. As described previously, the back panel 16 preferably includes cushioned material 58 for a more fitted and softer contact with the foot 116. If the back panel 16 does not include the cushion and the structures 64 and 66, it may include recessed portions (not illustrated) which allow one or more portions of the foot to rest within. The recessed portion may be an imprint of a foot to allow for securing the foot to the back panel 16.

Once the collapsible device 10 is no longer needed, the components can be disassembled, removed and placed into the bag 22. The bag 22 is stored until assembly is required.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A kit having a plurality of components for providing a disassembled leg support device comprising:
a first side wall having a first end, a second end, and a first side wall main body, said first side wall having at least one first connector member of a first connector assembly, and at least one first connector member of a second connector assembly;
a second side wall having a first end, a second end, and a second side wall main body, said second side wall having at least one first connector member of a first connector assembly, and at least one first connector member of a second connector assembly;
a back wall panel having a second connector member of a first connector assembly; and
at least one stabilizing member containing a second connector member of said second connector assembly sized and shaped to engage with said first connector member of a second connector assembly, whereby engagement of said connector members forms a second connector assembly;
wherein said components arranged together in an assembled configuration form a three-dimensional leg support device constructed and arranged to maintain one or more portions of a leg in a fixed position.

2. The kit having a plurality of components for a disassembled leg support device according to claim 1 wherein said first side wall or said second side wall contains at least one first connector member of a first connector assembly.

3. The kit having a plurality of components for a disassembled leg support device according to claim 1 further includes two stabilizing members.

4. The kit having a plurality of components for a disassembled leg support device according to claim 3 further including a bottom support member.

5. The kit having a plurality of components for a disassembled leg support device according to claim 4 wherein said bottom support member is a pillow.

6. The kit having a plurality of components for a disassembled leg support device according to claim 3 wherein said second connector member of said first connector assembly engages said first connector member in a first unsecured contact position, said second connector member is adapted for controlled movement relative to said engaged first connector member away from said first unsecured contact position to form a second position.

7. The kit having a plurality of components for a disassembled leg support device according to claim 6 wherein said first connector member of said first connector assembly includes a key-hole slotted member.

8. The kit having a plurality of components for a disassembled leg support device according to claim 7 wherein said second connector member of said first connector assembly includes a generally cylindrical body, said generally cylindrical body having a knob-like structure at one end sized and shaped to engage said key-hole slotted member.

9. The kit having a plurality of components for a disassembled leg support device according to claim 3 wherein said back wall panel further includes a cushion.

10. The kit having a plurality of components for a disassembled leg support device according to claim 3 wherein said back wall panel further includes foot support structures.

11. A collapsible leg support device having a plurality of components assembled together to form a three-dimensional configuration to maintain one or more portions of a human lower extremity in a fixed position comprising:
a first side wall having a first end, a second end, and a first side wall main body, said first side wall having at least one first connector member of a first connector assembly, and at least one first connector member of a second connector assembly;
a second side wall having a first end, a second end, and a second side wall main body, said side wall having at least one first connector member of a first connector assembly, and at least one first connector member of a second connector assembly;
said first and second walls arranged in a substantially parallel manner and spaced apart to form an area sized to contain one or more portions of a human lower extremity;
a back wall panel having a second connector member connector of said first connector assembly; and
at least one stabilizing member secured to said first and second side walls, said stabilizing member containing a second connector member of said second connector assembly.

12. The collapsible leg support device having a plurality of components assembled together to form a three-dimensional configuration to maintain one or more portions of a human lower extremity in a fixed position according to claim 11 wherein said first side wall or said second side wall contains at least one first connector member of a first connector assembly.

13. The collapsible leg support device having a plurality of components assembled together to form a three-dimensional configuration to maintain one or more portions of a human lower extremity in a fixed position according to claim 11 further includes two stabilizing members.

14. The collapsible leg support device having a plurality of components assembled together to form a three-dimensional configuration to maintain one or more portions of a human lower extremity in a fixed position according to claim 13 further including a bottom support member.

15. The collapsible leg support device having a plurality of components assembled together to form a three-dimensional configuration to maintain one or more portions of a human lower extremity in a fixed position according to claim 14 wherein said bottom support member is a pillow.

16. The collapsible leg support device having a plurality of components assembled together to form a three-dimensional configuration to maintain one or more portions of a human lower extremity in a fixed position according to claim 13 wherein said second connector member of said first connector assembly engages said first connector member in a first unsecured contact position, said second connector member is adapted for controlled movement relative to said engaged first connector member away from said first unsecured contact position to form a second position.

17. The collapsible leg support device having a plurality of components assembled together to form a three-dimensional configuration to maintain one or more portions of a human lower extremity in a fixed position according to claim 16 wherein said first connector member of said first connector assembly includes a key-hole slotted member.

18. The collapsible leg support device having a plurality of components assembled together to form a three-dimensional configuration to maintain one or more portions of a human lower extremity in a fixed position device according to claim 17 wherein said second connector member of said first connector assembly includes a generally cylindrical body, said generally cylindrical body having a knob-like structure at one end sized and shape to engage said key-hole slotted member.

19. The collapsible leg support device having a plurality of components assembled together to form a three-dimensional configuration to maintain one or more portions of a human lower extremity in a fixed position according to claim 13 wherein said back wall panel further includes a cushion.

20. The collapsible leg support device having a plurality of components assembled together to form a three-dimensional configuration to maintain one or more portions of a human lower extremity in a fixed position according to claim 13 wherein said back wall panel further includes foot support structures.
